(19) United States
(12) Patent Application Publication
(10) Pub. No.: US 2025/0220744 A1
(43) Pub. Date: Jul. 3, 2025

(54) CONNECTION ESTABLISHMENT METHOD, TERMINAL, AND NETWORK-SIDE DEVICE

(71) Applicant: VIVO MOBILE COMMUNICATION CO., LTD., Dongguan (CN)

(72) Inventor: Jiamin LIU, Dongguan (CN)

(73) Assignee: VIVO MOBILE COMMUNICATION CO., LTD., Dongguan (CN)

(21) Appl. No.: 19/082,134

(22) Filed: Mar. 17, 2025

Related U.S. Application Data
(63) Continuation of application No. PCT/CN2023/120592, filed on Sep. 22, 2023.

(30) Foreign Application Priority Data
Sep. 28, 2022 (CN) 202211193925.3

(51) Int. Cl. H04W 76/14; H04W 76/20; H04W 92/18

(52) U.S. Cl. CPC H04W 76/14; H04W 76/20; H04W 92/18

(57) ABSTRACT

A connection establishment method, a terminal, and a network-side device are provided. The connection establishment method includes: when there is a first path between a first terminal and a network-side device, sending, by the first terminal, first information to a second terminal or to the network-side device through a second terminal, where the first information is used to trigger establishment of a radio resource control (RRC) connection of the second terminal.

### CROSS-REFERENCE TO RELATED APPLICATIONS

This application is a continuation of International Application No. PCT/CN2023/120592, filed Sep. 22, 2023, which claims priority to Chinese Patent Application No. 202211193925.3, filed Sep. 28, 2022. The entire contents of each of the above-referenced applications are expressly incorporated herein by reference.

### TECHNICAL FIELD

This application pertains to the field of communication technologies, and specifically relates to a connection establishment method, a terminal, and a network-side device.

### BACKGROUND

A relay technology in a wireless communication system is to add one or more relay nodes between a base station and a terminal to be responsible for forwarding a wireless signal one or more times. For example, a wireless signal sent by a network-side device needs to pass through a plurality of hops to reach the terminal. In an example of a simple two-hop scenario, wireless relay is to divide a base station-terminal link into two links: base station-relay station and relay station-terminal, so that a poor-quality link can be replaced with two good-quality links to obtain a higher link capacity and better coverage.

FIG. 1 shows a typical relay scenario in which a remote terminal needs to transmit data to a network-side device, but due to poor coverage, a relay terminal is found for forwarding. There is a Uu interface between the relay terminal and the network-side device (for example, a base station) and a Sidelink (SL) interface (also referred to as a PC5 interface) between the relay terminal and the remote terminal. With rapid development of communication technologies, there is an increasingly large amount of network information, and transmitting signaling and/or data by a terminal by establishing a single path (a direct path or an indirect path) cannot meet a requirement for communication performance in terms of reliability, a throughput, and the like. Therefore, how to implement multi-path transmission between a terminal and a network-side device in a relay scenario is a technical problem that needs to be urgently resolved.

### SUMMARY

Embodiments of this application provide a connection establishment method, a terminal, and a network-side device.

According to a first aspect, a connection establishment method is provided, including:
when there is a first path between a first terminal and a network-side device, sending, by the first terminal, first information to a second terminal or to the network-side device through the second terminal, where the first information is used to trigger establishment of a radio resource control RRC connection of the second terminal.

According to a second aspect, a connection establishment method is provided, including:
receiving, by a second terminal, first information from the first terminal, where the first information is used to trigger establishment of a radio resource control RRC connection of the second terminal; and
establishing, by the second terminal, an RRC connection based on the first information, where the first information is sent when there is a first path between the first terminal and a network-side device, and is information sent to the second terminal or to the network-side device through the second terminal.

According to a third aspect, a connection establishment method is provided, including:
when there is a first path between a first terminal and a network-side device, receiving, by the network-side device, first information sent by the first terminal through a second terminal, where the first information is used to trigger establishment of a radio resource control RRC connection of the second terminal.

According to a fourth aspect, a connection establishment apparatus is provided, including:
a sending module, configured to: when there is a first path between a first terminal and a network-side device, send first information to a second terminal or to the network-side device through the second terminal, where the first information is used to trigger establishment of a radio resource control RRC connection of the second terminal.

According to a fifth aspect, a connection establishment apparatus is provided, including:
a receiving module, configured to receive first information from a first terminal, where the first information is used to trigger establishment of a radio resource control RRC connection of a second terminal; and
a processing module, configured to establish an RRC connection based on the first information, where the first information is sent when there is a first path between the first terminal and a network-side device, and is information sent to the second terminal or to the network-side device through the second terminal.

According to a sixth aspect, a connection establishment apparatus is provided, including:
a receiving module, configured to: when there is a first path between a first terminal and a network-side device, receive first information sent by the first terminal through a second terminal, where the first information is used to trigger establishment of a radio resource control RRC connection of the second terminal.

According to a seventh aspect, a first terminal is provided. The first terminal includes a processor and a memory. The memory stores a program or instructions capable of running on the processor, and when the program or the instructions are executed by the processor, the steps of the connection establishment method according to the first aspect are implemented.

According to an eighth aspect, a first terminal is provided, including a processor and a communication interface. The communication interface is configured to: when there is a first path between the first terminal and a network-side device, send first information to a second terminal or to the network-side device through a second terminal, where the first information is used to trigger establishment of a radio resource control RRC connection of the second terminal.

According to a ninth aspect, a second terminal is provided. The second terminal includes a processor and a memory. The memory stores a program or instructions capable of running on the processor, and when the program or the instructions are executed by the processor, the steps of the connection establishment method according to the second aspect are implemented.

According to a tenth aspect, a second terminal is provided, including a processor and a communication interface. The communication interface is configured to receive first information from a first terminal, where the first information is used to trigger establishment of a radio resource control RRC connection of the second terminal. The processor is configured to establish an RRC connection based on the first information, where the first information is sent when there is a first path between the first terminal and a network-side device, and is information sent to the second terminal or to the network-side device through the second terminal.

According to an eleventh aspect, a network-side device is provided. The network-side device includes a processor and a memory. The memory stores a program or instructions capable of running on the processor, and when the program or the instructions are executed by the processor, the steps of the connection establishment method according to the third aspect are implemented.

According to a twelfth aspect, a network-side device is provided, including a processor and a communication interface. The communication interface is configured to: when there is a first path between a first terminal and the network-side device, receive first information sent by the first terminal through a second terminal, where the first information is used to trigger establishment of a radio resource control RRC connection of the second terminal.

According to a thirteenth aspect, a communication system is provided, including a first terminal, a second terminal, and a network-side device. The first terminal may be configured to perform the steps of the connection establishment method according to the first aspect, the second terminal may be configured to perform the steps of the connection establishment method according to the second aspect, and the network-side device may be configured to perform the steps of the connection establishment method according to the third aspect.

According to a fourteenth aspect, a readable storage medium is provided. The readable storage medium stores a program or instructions, and when the program or the instructions are executed by a processor, the steps of the connection establishment method according to the first aspect are implemented, the steps of the connection establishment method according to the second aspect are implemented, or the steps of the connection establishment method according to the third aspect are implemented.

According to a fifteenth aspect, a chip is provided. The chip includes a processor and a communication interface. The communication interface is coupled to the processor, and the processor is configured to run a program or instructions to implement the steps of the connection establishment method according to the first aspect, the steps of the connection establishment method according to the second aspect, or the steps of the connection establishment method according to the third aspect.

According to a sixteenth aspect, a computer program/program product is provided. The computer program/program product is stored in a storage medium, and the computer program/program product is executed by at least one processor to implement the steps of the connection establishment method according to the first aspect, the steps of the connection establishment method according to the second aspect, or the steps of the connection establishment method according to the second aspect.

In the embodiments of this application, when there is a first path between a first terminal and a network-side device, the first terminal sends first information to a second terminal or to the network-side device through a second terminal, where the first information is used to trigger establishment of a radio resource control RRC connection of the second terminal. In this way, transmission between the first terminal and the network-side device can be performed through the existing first path and a path passing through the second terminal. This achieves high reliability and a high throughput, and improves terminal experience and system efficiency while ensuring a transmission effect.

### BRIEF DESCRIPTION OF DRAWINGS

FIG. 1 is a schematic diagram of a relay scenario from a terminal to a network according to an embodiment of this application;

FIG. 2 is a structural diagram of a wireless communication system applicable to an embodiment of this application;

FIG. 3 is a schematic diagram of a radio resource control connection setup procedure in a sidelink relay scenario according to an embodiment of this application;

FIG. 4a is a schematic diagram 1 of a multi-path scenario according to an embodiment of this application;

FIG. 4b is a schematic diagram 2 of a multi-path scenario according to an embodiment of this application;

FIG. 4c is a schematic diagram 3 of a multi-path scenario according to an embodiment of this application;

FIG. 5 is a schematic flowchart 1 of a connection establishment method according to an embodiment of this application;

FIG. 6 is a schematic flowchart 2 of a connection establishment method according to an embodiment of this application;

FIG. 7 is a schematic flowchart 3 of a connection establishment method according to an embodiment of this application;

FIG. 8 is a schematic structural diagram 1 of a connection establishment apparatus according to an embodiment of this application;

FIG. 9 is a schematic structural diagram 2 of a connection establishment apparatus according to an embodiment of this application;

FIG. 10 is a schematic structural diagram 3 of a connection establishment apparatus according to an embodiment of this application;

FIG. 11 is a schematic structural diagram of a communication device according to an embodiment of this application;

FIG. 12 is a schematic structural diagram of a terminal according to an embodiment of this application; and

FIG. 13 is a schematic structural diagram of a network-side device according to an embodiment of this application.

### DETAILED DESCRIPTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specified order or sequence. It should be understood that terms used in such a way are interchangeable under appropriate circumstances, so that the embodiments of this application can be implemented in an order other than that illustrated or described herein. In addition, the terms “first” and “second” typically distinguish between objects of a same type rather than limiting a quantity of objects. For example, there may be one or more first objects. In addition, in the specification and claims, “and/or” represents at least one of connected objects, and the character “/” usually represents an “or” relationship between associated objects.

It should be noted that a technology described in embodiments of this application is not limited to a Long Term Evolution (LTE)/LTE-Advanced (LTE-A) system, and may be further applied to other wireless communication systems, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-carrier Frequency Division Multiple Access (SC-FDMA) system, and another system. The terms “system” and “network” are often used interchangeably in the embodiments of this application. A technology described may be used for the systems and radio technologies described above, as well as other systems and radio technologies. A New Radio (NR) system is described in the following descriptions for illustrative purposes, and NR terms are used in most of the following descriptions. However, these technologies can also be applied to applications such as a 6th generation (6G) communication system other than NR system applications.

FIG. 2 is a block diagram of a wireless communication system applicable to an embodiment of this application. The wireless communication system includes a terminal 11 and a network-side device 12. The terminal 11 may be a mobile phone, a tablet personal computer, a laptop computer, or referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or furniture), a game machine, a personal computer (PC), a teller machine, a self-service machine, or another terminal-side device. The wearable device includes a smartwatch, a smart band, a smart headset, smart glasses, smart jewelry (a smart wristlet, a smart bracelet, a smart ring, a smart necklace, a smart anklet, a smart leglet, or the like), a smart wristband, a smart dress, or the like. It should be noted that a specific type of the terminal 11 is not limited in the embodiments of this application. The network-side device 12 may include an access network device or a core network device. The access network device may also be referred to as a wireless access network device, a Radio Access Network (RAN), a radio access network function, or a radio access network unit. The access network device may include a base station, a WLAN access point, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a transmission reception point (Transmitting Receiving Point, TRP), or another appropriate term in the field. Provided that a same technical effect is achieved, the base station is not limited to a specific technical vocabulary. It should be noted that in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a local NEF (Local NEF or L-NEF), a Binding Support Function (BSF), an Application Function (AF), or the like. It should be noted that in the embodiments of this application, only a core network device in the NR system is used as an example for description, and a specific type of the core network device is not limited.

Related concepts in the embodiments of this application are first described.

### (1) Sidelink Relay Mechanism

A relay technology in a wireless communication system is to add one or more relay nodes between a base station and a terminal to be responsible for forwarding a wireless signal one or more times, that is, the wireless signal needs to pass through a plurality of hops to reach the terminal. The wireless relay technology can be used not only to extend cell coverage and make up for cell coverage blind spots, but also to improve a cell capacity through spatial resource reuse. For indoor coverage, the relay technology can overcome a penetration loss and improve indoor coverage quality. In an example of simple two-hop relay, wireless relay is to divide a base station-terminal link into two links: base station-relay station and relay station-terminal, so that a poor-quality link can be replaced with two good-quality links to obtain a higher link capacity and better coverage.

A relay currently supported in a Long Term Evolution (LTE) system is a UE-to-network relay, that is, one end of the relay is connected to a terminal and the other end is connected to a network side. The terminal connected to the relay is referred to as a remote terminal.

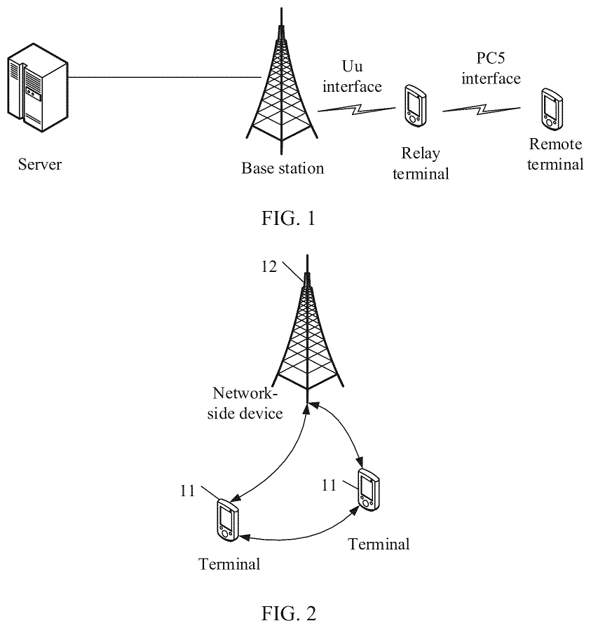

A New Radio (NR) system also needs to study how to support the UE-to-network relay mechanism. In a typical UE-to-network relay scenario shown in FIG. 1, a remote terminal needs to transmit data to a network side, but due to poor coverage, a relay terminal is found for forwarding. There is a Uu interface between the relay terminal and a base station and a sidelink (PC5) interface between the relay terminal and the remote terminal. Generally, the relay terminal is open and can serve any remote terminal.

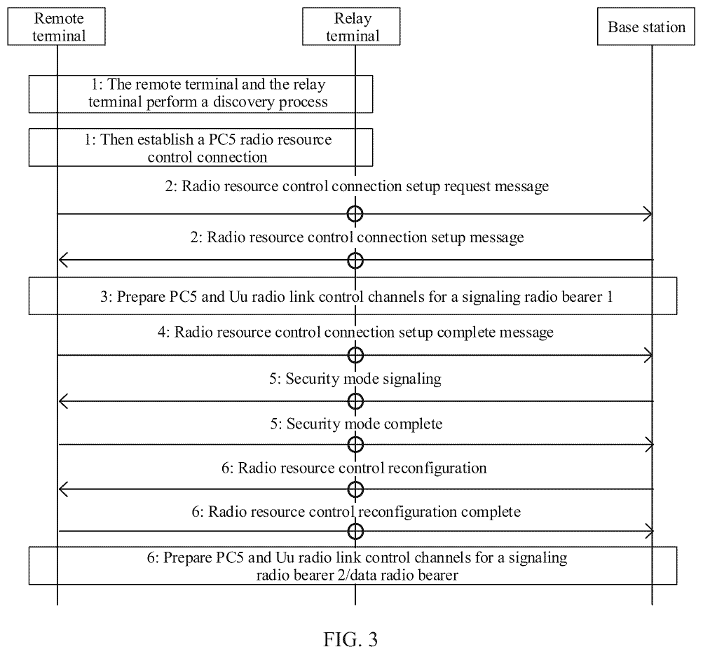

### (2) A Radio Resource Control (RRC) Connection Setup Procedure in a Sidelink Relay Scenario is Shown in FIG. 3

Step 1: A remote terminal and a relay terminal perform a discovery process, and then establish a PC5-RRC connection.

Step 2: The remote terminal sends an RRC setup request (RRCSetupRequest) message to a base station, and the base station replies to the remote terminal with an RRC setup (RRCSetup) message. In some embodiments, the two messages are sent to the base station or the remote terminal through forwarding by the relay terminal.

Step 3: Establish a dedicated Signaling Radio Bearer (SRB) between the base station and the remote terminal. The dedicated SRB1 bearer of the remote terminal includes two Radio Link Control (RLC) channels: PC5 (between the remote terminal and the relay terminal) and Uu (between the relay terminal and the base station). In some embodiments, the two RLC channels are used by the remote terminal to send/receive an SRB1-type RRC message between the remote terminal and the base station.

Step 4: The remote terminal sends an RRC setup complete (RRCSetupComplete) message to the base station. In some embodiments, the message is sent to the base station through forwarding by the relay terminal.

Step 5: Activate security between the remote terminal and the base station. An existing mechanism is reused for a message and a procedure for activating security.

Step 6: Establish a dedicated SRB2/Data Radio Bearers (DRB) between the base station and the remote terminal. The dedicated SRB2/DRB bearer of the remote UE includes two RLC channels: PC5 and Uu. In some embodiments, the two RLC channels are used by the remote terminal to send/receive an SRB2-type RRC/Non-Access Stratum (NAS) message and uplink/downlink service data between the remote terminal and the base station. In some embodiments, an existing RRC reconfiguration mechanism is reused.

### (3) Multi-Path Scenario

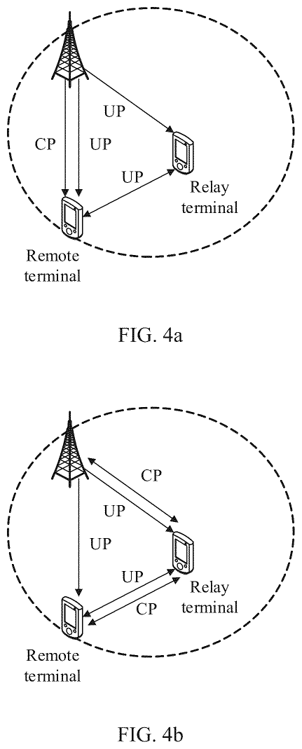

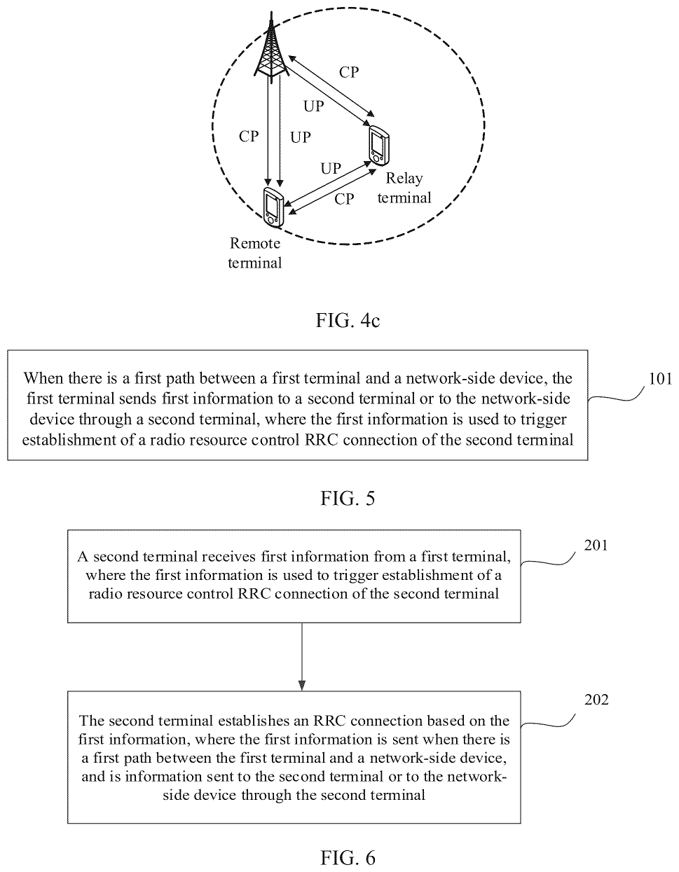

A multi-path scenario based on an SL relay architecture is shown in FIG. 4a to FIG. 4c. “Multi-path” means that a remote terminal establishes both an indirect path and a direct path. The indirect path refers to a radio link used by the remote terminal to perform data transmission with a base station through a relay terminal and a Uu air interface of the relay terminal. The direct path refers to a radio link used by the remote terminal to perform data transmission with the base station through a Uu air interface of the remote terminal. In FIG. 4a to FIG. 4c, CP refers to a control plane, and UP refers to a user plane.

Currently, in a solution in the prior art, the remote terminal is only supported in switching from a direct path to an indirect path, that is, when a new indirect path is established, a connection to the direct path is released, and when the new indirect path is established, a first end-to-end signaling radio bearer E2E SRB1 (End-to-End, Signaling Radio Bearer) message, for example, an RRC reconfiguration complete message, of the remote terminal is transmitted by using a default PC5 RLC bearer on a PC5 interface, to trigger, by using this message, the relay terminal that is still in an idle (IDLE)/non-connected (INACTIVE) state to enter an RRC connected state as soon as possible, and obtain configuration information of a bearer of the remote terminal from a network side, so as to complete establishment of a pipeline for a data radio bearer of the remote terminal to meet a requirement of the remote terminal for data transmission through the indirect path. However, when the remote terminal does not perform path switching but performs a path addition process, that is, when a second indirect path passing through the SL relay terminal is added on the basis of a direct path, a transmission path of the SRB1 does not necessarily need to be configured on the indirect path, and even if there is a transmission path of the SRB1, the SRB1 message is not necessarily transmitted on the indirect path. Therefore, the conventional manner of triggering, by using the first RRC reconfiguration complete message, the relay terminal to perform RRC state transition and obtain a configuration from the base station is not applicable. Therefore, a new solution needs to be further considered to ensure smooth addition of the indirect path for the remote terminal.

With reference to the accompanying drawings, the following describes, by using some embodiments and application scenarios thereof, in detail the connection establishment method provided in the embodiments of this application.

FIG. 5 is a schematic flowchart 1 of a connection establishment method according to an embodiment of this application. As shown in FIG. 5, the connection establishment method provided in this embodiment of this application includes the following steps.

Step 501: When there is a first path between a first terminal and a network-side device, the first terminal sends first information to a second terminal or to the network-side device through a second terminal, where the first information is used to trigger establishment of a radio resource control RRC connection of the second terminal.

In some embodiments, in the case in which there is the first path between the first terminal and the network-side device, that is, when there is a communication link between the first terminal and the network-side device and communication may be performed, the first terminal sends the first information to the second terminal or to the network-side device through the second terminal. The first information is used to trigger establishment of an RRC connection of the second terminal. After the second terminal receives the first information from the first terminal, the second terminal may obtain configuration information of a second path based on the first information, and establish a connection of the second path based on the configuration information of the second path. The second path is a path for the first terminal to reach the network-side device through the second terminal, and includes, for example, a path between the first terminal and the second terminal and a path between the second terminal and the network-side device. Therefore, in the case in which there is the first path between the first terminal and the network-side device, a second path passing through the second terminal is added to provide a data transmission service to the first terminal. This improves data transmission experience of the first terminal, achieves low implementation complexity, further improves system efficiency while ensuring terminal service experience, meets a requirement for communication performance in terms of reliability, a throughput, a delay, and the like, and improves communication quality.

In some embodiments, the first path is a direct path, and the second path is an indirect path; and the first terminal is a remote terminal, and the second terminal is a relay terminal.

In some embodiments, the first path may be an indirect path. This is not limited in embodiments of this application.

According to the method in the foregoing embodiment, when there is a first path between a first terminal and a network-side device, the first terminal sends first information to a second terminal or to the network-side device through a second terminal, where the first information is used to trigger establishment of a radio resource control RRC connection of the second terminal. In this way, transmission between the first terminal and the network-side device can be performed through the existing first path and a path passing through the second terminal. This achieves high reliability and a high throughput, and improves terminal experience and system efficiency while ensuring a transmission effect.

In some embodiments, that the first terminal sends first information to a second terminal or to the network-side device through a second terminal includes:

The first terminal receives first configuration information sent by the network-side device, where the first configuration information includes configuration information of a second path, and the second path is a path for the first terminal to reach the network-side device through the second terminal; and
the first terminal performs a target operation based on the first configuration information, and sends the first information to the second terminal through the second path or to the network-side device through the second terminal.

In some embodiments, to implement multi-path establishment, the configuration information of the second path that is sent by the network-side device to the first terminal includes, for example, configuration information of a PC5 link between the first terminal and the second terminal. In this way, after receiving the configuration information of the second path that is sent by the network-side device, the first terminal may send the first information to the second terminal through the second path or to the network-side device through the second terminal, to trigger establishment of the RRC connection of the second terminal. This implements multi-path establishment between the first terminal and the network-side device, meets a requirement for communication performance in terms of reliability, a throughput, and the like, and improves communication quality.

In some embodiments, the first information is a first signaling radio bearer SRB1 message, or the first information is an RRC reconfiguration complete message.

In some embodiments, the target operation performed by the first terminal based on the first configuration information includes any one of the following:
reconfiguring a transmission path of a first signaling radio bearer SRB message to the second path;
setting an RLC bearer corresponding to the second path to a main leg of the first SRB message; or
adding the second path, and setting a transmission path of the first information to a default path, where the default path is the second path.

In some embodiments, in a conventional SL relay switching scenario, the remote terminal directly switches from the direct path to the indirect path, that is, all SRB and DRB data of the remote terminal needs to be transmitted on the indirect path. Therefore, after path switching, the first SRB1 message (for example, an RRC reconfiguration complete message) of the remote terminal is carried on a default PC5 RLC bearer on a PC5 interface. After receiving data carried on the default PC5 RLC bearer, the relay terminal knows that this is a switching scenario of the remote terminal. Therefore, the first SRB1 message can trigger the relay terminal to establish or resume an RRC connection, so that the relay terminal can obtain a bearer configuration and mapping of the remote terminal from a network side, to provide a data forwarding service to the remote terminal.

However, in a multi-path addition scenario, a very important difference lies in that an original direct path of the remote terminal is retained, and a new indirect path is added as a supplement rather than a complete replacement. For example, the new indirect path may be added only for DRB splitting (split), and a path of the SRB1 is still retained on the direct path. Therefore, the first SRB1 message is transmitted through the direct path after reconfiguration, and state transition of the relay terminal cannot be triggered without passing through the relay terminal.

To implement transmission of the first SRB1 message on the indirect path after reconfiguration and trigger the relay terminal to establish or resume an RRC connection, in this embodiment of this application, a conventional manner of triggering a PC5 process of a first end-to-end SRB1 message may be reused. The network side configures the end-to-end SRB1 message of the remote terminal on the indirect path, and configures or enables, by default, the first SRB1 message to use an existing PC5 procedure to trigger the relay terminal to establish or resume an RRC connection. That is, a path of the SRB1 is forced, and the network-side device is forced, when the indirect path is added for the remote terminal, to configure transmission of the SRB1 on the indirect path and ensure transmission of at least the first SRB1 message on the indirect path. In this way, after the first terminal receives reconfiguration information for new path addition that is sent by the network-side device, the first terminal triggers, in a timely manner, the second terminal to enter an RRC connected state, so that the second terminal can obtain the configuration information of the second path from the network side as soon as possible, where the configuration information includes, for example, configuration information of a PC5 link between the first terminal and the second terminal and configuration information of a path between the second terminal and the network-side device, to provide a data transmission service to the first terminal. This may be implemented in the following manner:

In a first manner, the path of the first SRB message is directly switched from the direct path to the indirect path. For example, after receiving reconfiguration signaling, the first terminal may perform path switching of the SRB1, release mapping of the SRB1 and a corresponding Uu RLC bearer on the direct path, carry the SRB1 by using the default PC5 RLC bearer, and transfer the first SRB1 message to the second terminal by using the default PC5 RLC bearer after reconfiguration, to trigger the second terminal to enter the connected state to obtain the configuration information of the second path. In some embodiments, the first SRB message is an SRB1 message.

In a second manner, a split bearer is configured for the first SRB message, that is, a new indirect path is added, a new PC5 RLC bearer is added while an original Uu RLC bearer is retained, and the new PC5 RLC bearer is a default configuration. In a scenario in which there is multi-path transmission for the SRB1, there may be two manners to ensure that the first SRB1 message is definitely transmitted on the indirect link:
1. After the first terminal obtains the first configuration information sent by the network-side device, when a split SRB1 is configured, the indirect path or the PC5 RLC bearer is set to a main leg/default path, to indicate that SRB1 data is transmitted from the indirect path by default. In this way, the first SRB1 message can be transmitted on the indirect path.
2. A configuration of a main leg/default path of the split SRB1 is not changed, that is, a main path may still be the direct link. However, for the first SRB1 message after reconfiguration, after the first terminal obtains the first configuration information sent by the network-side device, the second path is added, and the transmission path of the first information is set to the default path, where the default path is the second path, that is, it is required that the first information needs to be transmitted on the indirect path. For example, as predefined in a protocol, the transmission path of the first information in this manner is the second path by default. The first information is a first signaling radio bearer SRB1 message.

According to the method in the foregoing embodiment, transmission of the SRB1 is added or migrated to the indirect path by reusing the conventional manner of triggering a PC5 process of a first end-to-end SRB1 message, to implement transmission of the first SRB1 message on the indirect path after reconfiguration, so as to trigger the second terminal to establish or resume an RRC connection. An implementation is simple and flexible.

In some embodiments, that the first terminal sends first information to a second terminal includes:

The first terminal sends the first information to the second terminal by using a discovery process; or
the first terminal sends the first information to the second terminal by using a target PC5 message, where the target PC5 message includes at least one of the following: a PC5-S message, a PC5-RRC message, or a PC5 layer 2 message.

In some embodiments, the first information includes at least one of the following: a multi-path indicator or an identifier of a data transmission service.

In some embodiments, to implement multi-path establishment, the first terminal needs to notify the second terminal to enter the connected state to obtain a configuration from a base station. In some embodiments, a PC5 notification manner may be used without limiting a path and message transmission of the SRB1, to ensure transmission flexibility of the SRB1 and enable the second terminal to enter the connected state. In some embodiments, the first terminal triggers, by using a signaling process of a PC5 interface, for example, the discovery process, a PC5-S signaling process, or a PC5-RRC signaling process, the second terminal to establish or resume an RRC connection. In some embodiments, the PC5 notification manner may be implemented in the following manner:
1. By using a discovery message, the discovery process is first required between the first terminal and the second terminal to determine that the second terminal can provide a required data transmission service to the first terminal. The discovery message needs to exchange specific relay content, for example, the identifier (service code) of the data transmission service. Further, in an SL relay multi-path scenario, to distinguish between a relay standalone scenario and a multi-path scenario, the discovery message may include an additional indication, for example, the multi-path indicator, used to indicate that this is a multi-path relay path.

In some embodiments, in an exchange process of the discovery message, the first terminal explicitly notifies, by using an explicit indication (the first information), the second terminal that the second terminal needs to enter the connected state to obtain a configuration of the second path, to trigger necessary state transition of the second terminal.
2. The first information is sent to the second terminal by using the target PC5 message. The target PC5 message includes at least one of the following: a PC5-S message, a PC5-RRC message, or a PC5 layer 2 message.
2-1. After it is determined, by completing a mutual discovery process between the first terminal and the second terminal by using the target PC5 message, that the second terminal can provide a required service to the first terminal, an upper-layer connection needs to be established between the two terminals by using the PC5-S signaling process, for example, a Direct Communication Request (DCR) message and a response. In this interaction process, the first terminal may also carry an explicit indication (the first information) to the second terminal to trigger the second terminal to perform necessary state transition, for example, explicitly indicate that this is an SL relay multi-path scenario. In some embodiments, the target PC5 message includes at least one of the following: a PC5-S message, a PC5-RRC message, or a PC5 layer 2 message.

In some embodiments, the discovery process and the PC5-S process may be combined, that is, both discovery and upper-layer signaling connection establishment are completed in one process. In some embodiments, in a combination process, an explicit indication may be carried to trigger a behavior of the second terminal.
2-2. The first information may be sent to the second terminal by using the PC5-RRC message or another PC5 layer 2 (L2) message, for example, a Media Access Control Control Element (MAC CE), PC5-RRC signaling, or the PC5 L2 message. In some embodiments, a new dedicated message may be used by the first terminal to trigger the second terminal to perform state transition. For example, for PC5-RRC, new multi-path addition triggering signaling or a corresponding MAC CE is used to trigger the second terminal to perform necessary state transition. The MAC CE needs to indicate that this is a path triggering message. For example, a dedicated Logical Channel Identifier (LCID) indication is used. The PC5-RRC message or the PC5 L2 message may be sent to the second terminal when the first terminal is ready to return the first SRB1 message, so that the second terminal makes an RRC state change.

In some embodiments, that the first terminal sends first information to a second terminal includes:

The first terminal sends the first information to the second terminal by using a first RLC bearer on a default PC5 interface.

In some embodiments, to implement multi-path establishment, the first terminal needs to notify the second terminal to enter the connected state to obtain a configuration from a base station. In some embodiments, the first terminal may send the first information to the second terminal by using the first RLC bearer on the default PC5 interface, that is, trigger, by sending non-SRB1 data on the PC5 interface, the second terminal to make an RRC state change, to ensure transmission flexibility of the SRB1 and enable the second terminal to enter the connected state.

In some embodiments, the first RLC bearer meets at least one of the following:

The first RLC bearer is a common PC5 RLC bearer reserved for a non-SRB0 and/or a non-SRB1;
the first RLC bearer is an RLC bearer separately reserved for at least two types of data; or
the first RLC bearer is an RLC bearer separately reserved for at least two data transmission requirements.

For example, in a conventional SL relay scenario, a default PC5 RLC bearer configuration is reserved for both an SRB0 and an SRB1 of the remote terminal on the PC5 interface, and a configuration parameter of the RLC bearer and a corresponding specific LCID value are explicitly specified. In this way, once the relay terminal receives data from the remote terminal based on a specific LCID, the relay terminal can know that this is an end-to-end SRB0 or SRB1 message from the remote terminal, then triggers a state change to enter the connected state, makes a report to the base station, and obtains a configuration.

Therefore, based on the foregoing principle, a default PC5 RLC bearer configuration may also be reserved for other data from the first terminal on the PC5 interface, and a configuration parameter of the RLC bearer and a corresponding LCID value may be agreed upon. In some embodiments, a default common PC5 RLC bearer is reserved for all non-SRB0 and non-SRB1 data. A configuration of the PC5 RLC bearer needs to meet transmission requirements of most SRBs and DRBs, for example, an RLC Unacknowledged Mode (UM), an RLC Acknowledged Mode (AM), and LCID=7, to trigger, by sending the non-SRB1 data on the PC5 interface, the second terminal to make an RRC state change.

In some embodiments, RLC bearers may be respectively reserved for different types of data based on data type classification, that is, different types of data may correspond to different RLC bearers. For example, respective corresponding PC5 RLC bearers are reserved for an SRB2 or other SRBs, to meet an SRB transmission requirement, for example, an RLC AM mode and LCID=7; and a PC5 RLC bearer is reserved for all DRB data, to meet a DRB transmission requirement, for example, an RLC UM mode and LCID=8, to trigger, by sending the non-SRB1 data on the PC5 interface, the second terminal to make an RRC state change.

In some embodiments, two or more RLC bearers may be reserved based on different transmission requirements. For example, a PC5 RLC bearer 1 is reserved for a high priority, an RLC UM mode, and LCID=7, and a PC5 RLC bearer 2 is reserved for a low priority, an RLC AM mode, and LCID=8. An appropriate RLC bearer is selected for transmission based on an attribute of SRB or DRB data. A mapping relationship between data and an RLC bearer may also be agreed upon or configured in advance. For example, an SRB2 is transmitted on an LCID 8, a UM DRB is transmitted on an LCID 7, and an AM DRB is transmitted on the LCID 8.

According to the method in the foregoing embodiment, more PC5 RLC bearers are reserved for the first terminal on the PC5 interface, so that the first terminal can transmit data that is in the first information and that is offloaded onto the indirect path on a corresponding PC5 RLC bearer based on an actual data transmission requirement, to trigger, by using the first RLC bearer on the default PC5 interface, the second terminal to perform state transition and a subsequent process, so as to implement application of the multi-path scenario.

In some embodiments, the first information is data or signaling to be transmitted to the network-side device, and that the first terminal sends the first information to the second terminal by using a first RLC bearer on a default PC5 interface includes:
reconfiguring a transmission path of the first information from the first path to the first RLC bearer, and sending the first information to the second terminal on the first RLC bearer; or
sending the first information to the second terminal on the first RLC bearer in a transmission repetition manner.

A specific implementation is as follows:
1. Change of a routing mechanism: A route of at least one piece of to-be-transmitted data or signaling may be changed from original transmission on the first path to transmission on the default first RLC bearer, and the first information may be sent to the second terminal on the first RLC bearer.
2. Use of a transmission repetition mechanism: The transmission repetition mechanism is used for at least one piece of to-be-transmitted data or signaling, and a repeated data packet is transmitted on both the first path and the default first RLC bearer, to send the first information to the second terminal on the first RLC bearer.

In some embodiments, that the first terminal sends the first information to the second terminal by using a first RLC bearer on a default PC5 interface includes:

When the first information does not meet a target condition for transmission on a second path, the first terminal sends the first information to the second terminal by using the first RLC bearer, where
the target condition is that an amount of cached data is greater than or equal to a first threshold.

When a new second path is established, for example, when a new path of an SRB2 or a DRB is added, it is possible that there is currently no to-be-transmitted data on the SRB2 or the DRB on the second path. A reason why there is no to-be-transmitted data may be that there is actually no data corresponding to the bearer in a current cache, or there is data corresponding to the bearer in a cache, but a condition for transmission on the new second path is not met. For example, a split DRB is configured, and there is a leg/path/RLC bearer on each of the first path and the second path, but the first path is set to a main leg/main path/default path. Generally, data is transmitted only on the main leg, and transmission on any leg is triggered only when the amount of cached data is greater than the first threshold, that is, when the amount of cached data is greater than the first threshold. Therefore, when the first information does not meet the target condition for transmission on the second path, the first terminal may send the first information to the second terminal by using the first RLC bearer on the default PC5 interface.

In some embodiments, that the first terminal sends the first information to the second terminal by using a first RLC bearer on a default PC5 interface includes:

When the first terminal has no data or signaling to be transmitted to the network-side device, the first terminal sends the first information to the second terminal on the first RLC bearer, where the first information is a control data packet; or
when the first terminal has no data or signaling to be transmitted to the network-side device, the first terminal retransmits the first information to the second terminal on the first RLC bearer, where the first information is unacknowledged data of the first terminal.

In some embodiments, the first information includes at least one of the following: a data packet type or a dedicated logical channel identifier LCID.

In some embodiments, in the case in which the first terminal has no data or signaling to be transmitted to the network-side device, sending of a control data packet may be triggered, for example, a layer 2 control data packet (Protocol Data Unit (PDU)), a new MAC CE, a radio link control RLC layer control data packet (RLC control PDU) triggered in a new RLC entity, a new Packet Data Convergence Protocol (PDCP) layer control data packet, or a Service Data Adaptation Protocol (SDAP) layer control data packet. In some embodiments, a function of the control data packet needs to be identified in the control data packet, for example, a special LCID is used for the MAC CE or there is a special PDU type in the control PDU, to trigger the second terminal to establish an RRC connection, that is, to indicate that the control data packet is a multi-path triggering indication. In some embodiments, the control data packet does not need to carry specific content. In some embodiments, if the L2 control data packet is a MAC or RLC layer control data packet, the control data packet may be deleted after being received by the second terminal, and is merely used to trigger a subsequent action of the second terminal. If the L2 control data packet is a PDCP or SDAP layer control data packet, the control data packet needs to be sent to a corresponding receiving entity of the network-side device (for example, a base station gNB). The control data packet may also be used as a first data identifier for activating the second path. Once the network-side device receives the control data packet, it indicates that the second path is successfully established, and data transmission may be subsequently performed.

In some embodiments, in the case in which the first terminal has no data or signaling to be transmitted to the network-side device, retransmission of unacknowledged data may be triggered. For example, a data packet that is not acknowledged by an original RLC entity is selected from a PDCP layer of the first terminal and is retransmitted to a new second path.

It should be noted that when the first information is sent to the second terminal by using the first RLC bearer on the default PC5 interface, to trigger the second terminal to make an RRC state change, the foregoing manners may be used together. For example, when there is to-be-transmitted data or signaling in the cache, the manner of changing a routing mechanism may be used to reconfigure the transmission path of the first information from the first path to the second path, and/or the first information may be sent to the second terminal on the first RLC bearer in the transmission repetition manner, to avoid a waste of transmission resources. For example, the transmission repetition manner may be selected in a case of high reliability. When there is no to-be-transmitted data or signaling in the cache, the first information may be unacknowledged data of the first terminal, and the first terminal retransmits the first information to the second terminal on the first RLC bearer. If there is no unsuccessful data packet, the manner of sending a control data packet may be used, that is, the first information is a control data packet, and the first terminal sends the first information to the second terminal on the first RLC bearer. That is, the first information is sent to the second terminal by flexibly using the first RLC bearer on the default PC5 interface, to trigger the second terminal to make an RRC state change, so as to implement application of the multi-path scenario.

In some embodiments, that the first terminal sends first information to a second terminal or to the network-side device through a second terminal includes:

When a connection state of the second terminal is an idle state or an inactive state, the first terminal sends the first information to the second terminal or to the network-side device through the second terminal.

In some embodiments, it cannot be ensured that a second terminal adjacent to the first terminal is definitely in a connected state. To select the adjacent second terminal as much as possible and ensure that link quality of a PC5 interface meets a communication requirement, second terminals in all states need to be considered. When the network-side device selects a target second terminal based on a measurement report from the first terminal, if the second terminal is in an idle or inactive (IDLE/INACTIVE) state, after receiving a multi-path reconfiguration message, the first terminal needs to send the first information to the second terminal or to the network-side device through the second terminal, to trigger the target second terminal to enter a connected state. Then, the second terminal reports an identity of the second terminal to the network-side device, for example, sidelink terminal information (Sidelink UE information), carrying a layer 2 identifier L2ID of the second terminal, an L2 ID of the first terminal, and a relay objective or a multi-path relay objective. In this way, after receiving the report, the network-side device sends bearer information and configuration information corresponding to the first terminal to the second terminal, for example, configurations of a Uu RLC bearer and a PC5 RLC bearer added for the second terminal and a mapping relationship between an E2E radio bearer RB and RLC bearer of the first terminal, to perform subsequent transmission through a transmission channel of a second path newly added for the second terminal.

In some embodiments, the method further includes:

The first terminal receives first indication information sent by the network-side device, where the first indication information is used to indicate a manner in which the first terminal sends the first information.

In some embodiments, for example, the manner in which the first terminal sends the first information reuses the conventional manner of triggering a PC5 process of a first E2E SRB1 message, is sent by using the first RLC bearer on the default PC5 interface, is sent by using the discovery process, is sent by using to-be-transmitted data or signaling, or may be indicated to the first terminal by using the first indication information sent by the network-side device, for example, an explicit indication or an implicit indication, or the first terminal independently performs execution based on a configuration of the first terminal.

In some embodiments, the method further includes:

The first terminal receives a notification message sent by the network-side device or the second terminal, where the notification message is used to notify a connection state of the second terminal.

In some embodiments, the connection state includes at least one of the following: an idle state, an inactive state, or an RRC connected state.

In some embodiments, for multi-path triggering of the second terminal by the first terminal, a dedicated signaling or message process is required in some of the foregoing manners (for example, a dedicated control plane or a control data packet is sent). To avoid additional overheads, an RRC state of the second terminal may be notified by the network-side device to the first terminal or notified by the second terminal to the first terminal, that is, the network-side device or the second terminal sends the notification message to the first terminal, where the notification message is used to notify the connection state of the second terminal, so that after receiving the notification message sent by the network-side device or the second terminal, the first terminal determines whether to perform a PC5 triggering process. In some embodiments, for a user plane UP triggering manner, normal data transmission is usually used, and there are no additional overheads. Therefore, a state of the second terminal may not be considered.

In some embodiments, for the first terminal, the RRC state of the second terminal may be not distinguished, and a uniform triggering manner is used. The second terminal determines a subsequent processing manner based on a state of the second terminal. If the second terminal is in the idle/inactive state, an RRC connection is established or resumed, a report is made, and a configuration is obtained. If the second terminal is in the connected state, an RRC state transition process may be omitted.

In this embodiment of this application, the method for adding an indirect path on the basis of a direct path in an SL relay scenario is used as an example, so that the remote terminal can trigger, in a CP or UP manner, the relay terminal to perform RRC state transition. In this way, the relay terminal can obtain end-to-end bearer configuration and mapping information of the remote terminal from the network side in a timely manner, to ensure that multi-path transmission of the remote terminal can be performed in a timely and normal manner. This improves terminal experience and system efficiency while ensuring a transmission effect.

FIG. 6 is a schematic flowchart 2 of a connection establishment method according to an embodiment of this application. As shown in FIG. 6, the connection establishment method provided in this embodiment of this application includes the following steps.

Step 201: A second terminal receives first information from a first terminal, where the first information is used to trigger establishment of a radio resource control RRC connection of the second terminal.

Step 202: The second terminal establishes an RRC connection based on the first information, where the first information is sent when there is a first path between the first terminal and a network-side device, and is information sent to the second terminal or to the network-side device through the second terminal.

In some embodiments, that a second terminal receives first information from a first terminal includes:

The second terminal receives the first information sent by the first terminal through a second path, where the first information is sent after the first terminal performs a target operation based on first configuration information sent by the network-side device, the first configuration information includes configuration information of the second path, and the second path is a path for the first terminal to reach the network-side device through the second terminal.

In some embodiments, the target operation includes any one of the following:
reconfiguring a transmission path of a first signaling radio bearer SRB message to the second path;
setting an RLC bearer corresponding to the second path to a main leg of the first SRB message; or
adding the second path, and setting a transmission path of the first information to a default path, where the default path is the second path.

In some embodiments, the first SRB message is an SRB1 message.

In some embodiments, the first information is a first signaling radio bearer SRB1 message, or the first information is an RRC reconfiguration complete message.

In some embodiments, that a second terminal receives first information from a first terminal includes:

The second terminal receives the first information sent by the first terminal by using a discovery process; or
the second terminal receives the first information sent by the first terminal by using a target PC5 message, where the target PC5 message includes at least one of the following: a PC5-S message, a PC5-RRC message, or a PC5 layer 2 message.

In some embodiments, the first information includes at least one of the following: a multi-path indicator or an identifier of a data transmission service.

In some embodiments, that a second terminal receives first information from a first terminal includes:

The second terminal receives the first information sent by the first terminal by using a first RLC bearer on a default PC5 interface.

In some embodiments, the first information is data or signaling to be transmitted to the network-side device, and that the second terminal receives the first information sent by the first terminal by using a first RLC bearer on a default PC5 interface includes:

The second terminal receives the first information sent by the first terminal on the first RLC bearer, where a transmission path of the first information is reconfigured from the first path to the first RLC bearer; or
the second terminal receives the first information sent by the first terminal on the first RLC bearer in a transmission repetition manner.

In some embodiments, that the second terminal receives the first information sent by the first terminal by using a first RLC bearer on a default PC5 interface includes:

When the first information does not meet a target condition for transmission on a second path, the second terminal receives the first information sent by the first terminal by using the first RLC bearer, where
the target condition is that an amount of cached data is greater than or equal to a first threshold.

In some embodiments, that the second terminal receives the first information sent by the first terminal by using a first RLC bearer on a default PC5 interface includes:

When the first terminal has no data or signaling to be transmitted to the network-side device, the second terminal receives the first information sent by the first terminal on the first RLC bearer, where the first information is a control data packet; or
when the first terminal has no data or signaling to be transmitted to the network-side device, the second terminal receives the first information retransmitted by the first terminal on the first RLC bearer, where the first information is unacknowledged data of the first terminal.

In some embodiments, the first RLC bearer meets at least one of the following:

The first RLC bearer is a common PC5 RLC bearer reserved for a non-SRB0 and/or a non-SRB1;
the first RLC bearer is an RLC bearer separately reserved for at least two types of data; or
the first RLC bearer is an RLC bearer separately reserved for at least two data transmission requirements.

In some embodiments, the control data packet includes at least one of the following:
a layer 2 control data packet, a radio link control RLC layer control data packet, a packet data convergence protocol PDCP layer control data packet, or a service data adaptation protocol SDAP layer control data packet.

In some embodiments, when the control data packet is a PDCP layer control data packet or an SDAP layer control data packet, the control data packet is a data packet that needs to be sent to the network-side device.

In some embodiments, the first information includes at least one of the following: a data packet type or a dedicated logical channel identifier LCID.

In some embodiments, the first information is sent when a connection state of the second terminal is an idle state or an inactive state.

In some embodiments, the method further includes:

The second terminal sends a notification message to the first terminal, where the notification message is used to notify a connection state of the second terminal.

In some embodiments, the first path is a direct path, and the second path is an indirect path.

A specific implementation process and technical effects of the method in this embodiment are the same as those in the method embodiment on the first terminal side. For details, refer to the detailed descriptions in the method embodiment on the first terminal side. Details are not described herein again.

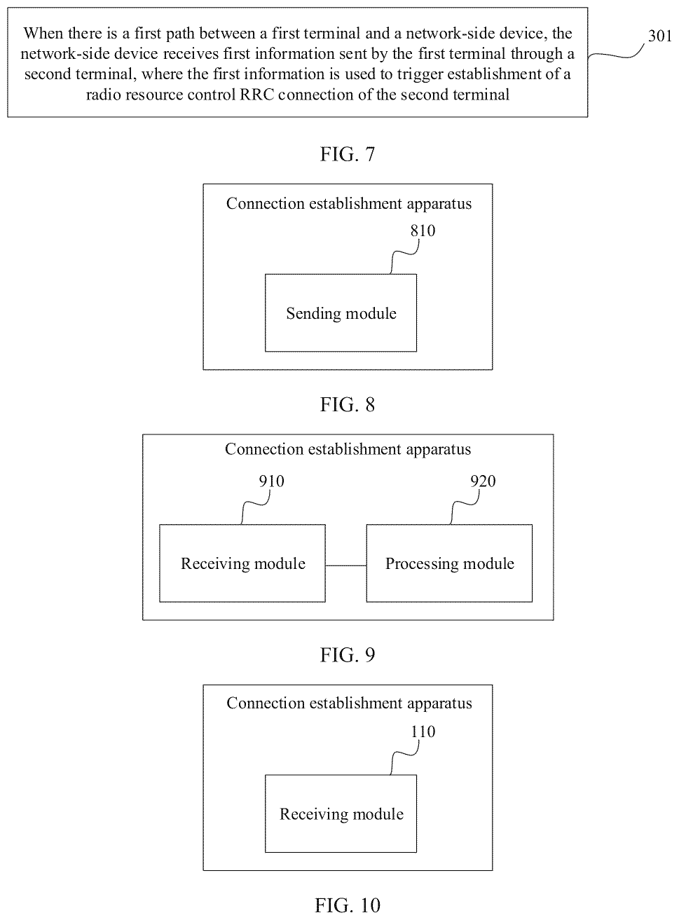

FIG. 7 is a schematic flowchart 3 of a connection establishment method according to an embodiment of this application. As shown in FIG. 7, the connection establishment method provided in this embodiment of this application includes the following steps.

Step 301: When there is a first path between a first terminal and a network-side device, the network-side device receives first information sent by the first terminal through a second terminal, where the first information is used to trigger establishment of a radio resource control RRC connection of the second terminal.

In some embodiments, before the network-side device receives the first information sent by the first terminal through the second terminal, the method further includes:

The network-side device sends first configuration information to the first terminal, where the first configuration information includes configuration information of a second path, and the second path is a path for the first terminal to reach the network-side device through the second terminal.

In some embodiments, the first information is sent after the first terminal performs a target operation, and the target operation includes any one of the following:
reconfiguring a transmission path of a first signaling radio bearer SRB message to the second path;
setting an RLC bearer corresponding to the second path to a main leg of the first SRB message; or
adding the second path, and setting a transmission path of the first information to a default path, where the default path is the second path.

In some embodiments, the first SRB message is an SRB1 message.

In some embodiments, the first information is a first signaling radio bearer SRB1 message, or the first information is an RRC reconfiguration complete message.

In some embodiments, the first information is sent when a connection state of the second terminal is an idle state or an inactive state.

In some embodiments, the method further includes:

The network-side device sends first indication information to the first terminal, where the first indication information is used to indicate a manner in which the first terminal sends the first information.

In some embodiments, the method further includes:

The network-side device sends a notification message to the first terminal, where the notification message is used to notify a connection state of the second terminal.

In some embodiments, the first path is a direct path, and the second path is an indirect path.

A specific implementation process and technical effects of the method in this embodiment are the same as those in the method embodiment on the first terminal side. For details, refer to the detailed descriptions in the method embodiment on the first terminal side. Details are not described herein again.

The connection establishment method provided in the embodiments of this application may be performed by a connection establishment apparatus. In the embodiments of this application, the connection establishment apparatus provided in the embodiments of this application is described by using an example in which the connection establishment apparatus performs the connection establishment method.

FIG. 8 is a schematic structural diagram 1 of a connection establishment apparatus according to an embodiment of this application. As shown in FIG. 8, the connection establishment apparatus includes:
a sending module 810, configured to: when there is a first path between a first terminal and a network-side device, send first information to a second terminal or to the network-side device through a second terminal, where the first information is used to trigger establishment of a radio resource control RRC connection of the second terminal.

In some embodiments, the connection establishment apparatus further includes a receiving module, configured to receive first configuration information sent by the network-side device, where the first configuration information includes configuration information of a second path, and the second path includes a path between the first terminal and the second terminal and a path between the second terminal and the network-side device.

In some embodiments, the sending module 810 is further configured to send the first information to the second terminal through the second path or to the network-side device through the second terminal based on the first configuration information.

In some embodiments, the sending module 810 is configured to perform a target

operation based on the first configuration information, where the target operation includes any one of the following:
reconfiguring a transmission path of a first signaling radio bearer SRB message to the second path;
setting an RLC bearer corresponding to the second path to a main leg of the first SRB message; or
adding the second path, and setting a transmission path of the first information to a default path, where the default path is the second path.

In some embodiments, the first SRB message is an SRB1 message.

In some embodiments, the first information is a first signaling radio bearer SRB1 message.

In some embodiments, the sending module 810 is further configured to send the first information to the second terminal by using a discovery process; or
send the first information to the second terminal by using a target PC5 message, where the target PC5 message includes at least one of the following: a PC5-S message, a PC5-RRC message, or a PC5 layer 2 message.

In some embodiments, the first information includes a multi-path indicator and an identifier of a data transmission service.

In some embodiments, the sending module 810 is further configured to send the first information to the second terminal by using a first RLC bearer on a default PC5 interface.

In some embodiments, the first information is data or signaling to be transmitted to the network-side device, and the sending module 810 is configured to:
reconfigure a transmission path of the first information from the first path to the first RLC bearer, and send the first information to the second terminal on the first RLC bearer through the second path; or
send the first information to the second terminal on the first RLC bearer in a transmission repetition manner through the second path.

In some embodiments, the sending module 810 is further configured to: when the first information does not meet a target condition for transmission on a second path, send the first information to the second terminal by using the first RLC bearer, where
the target condition is that an amount of cached data is greater than or equal to a first threshold.

In some embodiments, the sending module 810 is further configured to:
when the first terminal has no to-be-transmitted data, send the first information to the second terminal on the first RLC bearer, where the first information is a control data packet; or
when the first terminal has no to-be-transmitted data, retransmit the first information to the second terminal on the first RLC bearer, where the first information is unacknowledged data of the first terminal.

In some embodiments, the first RLC bearer meets at least one of the following:

The first RLC bearer is a common PC5 RLC bearer reserved for a non-SRB0 and/or a non-SRB1;
the first RLC bearer is an RLC bearer separately reserved for at least two types of data; or
the first RLC bearer is an RLC bearer separately reserved for at least two data transmission requirements.

In some embodiments, the control data packet includes at least one of the following:
a layer 2 control data packet, a radio link control RLC layer control data packet, a packet data convergence protocol PDCP layer control data packet, or a service data adaptation protocol SDAP layer control data packet.

In some embodiments, when the control data packet is a PDCP layer control data packet or an SDAP layer control data packet, the control data packet is a data packet that needs to be sent to the network-side device.

In some embodiments, the first information includes a data packet type and a dedicated logical channel identifier LCID.

In some embodiments, the sending module 810 is further configured to:
when a connection state of the second terminal is an idle state or an inactive state, send the first information to the second terminal or to the network-side device through the second terminal.

In some embodiments, the receiving module is further configured to receive first indication information sent by the network-side device, where the first indication information is used to indicate a manner in which the first terminal sends the first information.

In some embodiments, the receiving module is further configured to receive a notification message sent by the network-side device or the second terminal, where the notification message is used to notify a connection state of the second terminal.

In some embodiments, the first path is a direct path, and the second path is an indirect path.

The apparatus in this embodiment may be configured to perform the method in any one of the method embodiments on the first terminal side. A specific implementation process and technical effects of the apparatus are the same as those in the method embodiment on the first terminal side. For details, refer to the detailed descriptions in the method embodiment on the first terminal side. Details are not described herein again.

FIG. 9 is a schematic structural diagram 2 of a connection establishment apparatus according to an embodiment of this application. As shown in FIG. 9, the connection establishment apparatus includes:
a receiving module 910, configured to receive first information from a first terminal, where the first information is used to trigger establishment of a radio resource control RRC connection of a second terminal; and
a processing module 920, configured to establish an RRC connection based on the first information, where the first information is sent when there is a first path between the first terminal and a network-side device, and is information sent to the second terminal or to the network-side device through the second terminal.

In some embodiments, the receiving module 910 is configured to:
receive the first information sent by the first terminal through a second path, where the first information is sent after the first terminal performs a target operation based on first configuration information sent by the network-side device, the first configuration information includes configuration information of the second path, and the second path is a path for the first terminal to reach the network-side device through the second terminal.

In some embodiments, the target operation includes any one of the following:
reconfiguring a transmission path of a first signaling radio bearer SRB message to the second path;
setting an RLC bearer corresponding to the second path to a main leg of the first SRB message; or
adding the second path, and setting a transmission path of the first information to a default path, where the default path is the second path.

In some embodiments, the first SRB message is an SRB1 message.

In some embodiments, the first information is a first signaling radio bearer SRB1 message, or the first information is an RRC reconfiguration complete message.

In some embodiments, the receiving module 910 is configured to:
receive the first information sent by the first terminal by using a discovery process; or
receive the first information sent by the first terminal by using a target PC5 message, where the target PC5 message includes at least one of the following: a PC5-S message, a PC5-RRC message, or a PC5 layer 2 message.

In some embodiments, the first information includes at least one of the following: a multi-path indicator or an identifier of a data transmission service.

In some embodiments, the receiving module 910 is configured to:
receive the first information sent by the first terminal by using a first RLC bearer on a default PC5 interface.

In some embodiments, the first information is data or signaling to be transmitted to the network-side device, and the receiving module 910 is configured to:
receive the first information sent by the first terminal on the first RLC bearer, where a transmission path of the first information is reconfigured from the first path to the first RLC bearer; or
receive the first information sent by the first terminal on the first RLC bearer in a transmission repetition manner.

In some embodiments, the receiving module 910 is configured to:
when the first information does not meet a target condition for transmission on a second path, receive the first information sent by the first terminal by using the first RLC bearer, where
the target condition is that an amount of cached data is greater than or equal to a first threshold.

In some embodiments, the receiving module 910 is configured to:
when the first terminal has no data or signaling to be transmitted to the network-side device, receive the first information sent by the first terminal on the first RLC bearer, where the first information is a control data packet; or
when the first terminal has no data or signaling to be transmitted to the network-side device, receive the first information retransmitted by the first terminal on the first RLC bearer, where the first information is unacknowledged data of the first terminal.

In some embodiments, the first RLC bearer meets at least one of the following:

The first RLC bearer is a common PC5 RLC bearer reserved for a non-SRB0 and/or a non-SRB1;
the first RLC bearer is an RLC bearer separately reserved for at least two types of data; or
the first RLC bearer is an RLC bearer separately reserved for at least two data transmission requirements.

In some embodiments, the control data packet includes at least one of the following:
a layer 2 control data packet, a radio link control RLC layer control data packet, a packet data convergence protocol PDCP layer control data packet, or a service data adaptation protocol SDAP layer control data packet.

In some embodiments, when the control data packet is a PDCP layer control data packet or an SDAP layer control data packet, the control data packet is a data packet that needs to be sent to the network-side device.

In some embodiments, the first information includes at least one of the following: a data packet type or a dedicated logical channel identifier LCID.

In some embodiments, the first information is sent when a connection state of the second terminal is an idle state or an inactive state.

In some embodiments, the second terminal sends a notification message to the first terminal, where the notification message is used to notify a connection state of the second terminal.

In some embodiments, the first path is a direct path, and the second path is an indirect path.

The apparatus in this embodiment may be configured to perform the method in any one of the method embodiments on the second terminal side. A specific implementation process and technical effects of the apparatus are the same as those in the method embodiment on the second terminal side. For details, refer to the detailed descriptions in the method embodiment on the second terminal side. Details are not described herein again.

FIG. 10 is a schematic structural diagram 3 of a connection establishment apparatus according to an embodiment of this application. As shown in FIG. 10, the connection establishment apparatus includes:
a receiving module 110, configured to: when there is a first path between a first terminal and a network-side device, receive first information sent by the first terminal through a second terminal, where the first information is used to trigger establishment of a radio resource control RRC connection of the second terminal.

In some embodiments, the apparatus further includes:
a sending module, configured to send first configuration information to the first terminal, where the first configuration information includes configuration information of a second path, and the second path is a path for the first terminal to reach the network-side device through the second terminal.

In some embodiments, the first information is sent after the first terminal performs a target operation, and the target operation includes any one of the following:
reconfiguring a transmission path of a first signaling radio bearer SRB message to the second path;
setting an RLC bearer corresponding to the second path to a main leg of the first SRB message; or
adding the second path, and setting a transmission path of the first information to a default path, where the default path is the second path.

In some embodiments, the first SRB message is an SRB1 message.

In some embodiments, the first information is a first signaling radio bearer SRB1 message, or the first information is an RRC reconfiguration complete message.

In some embodiments, the first information is sent when a connection state of the second terminal is an idle state or an inactive state.

In some embodiments, the sending module is further configured to:
send first indication information to the first terminal, where the first indication information is used to indicate a manner in which the first terminal sends the first information.

In some embodiments, the sending module is further configured to:
send a notification message to the first terminal, where the notification message is used to notify a connection state of the second terminal.

In some embodiments, the first path is a direct path, and the second path is an indirect path.

The apparatus in this embodiment may be configured to perform the method in any one of the method embodiments on the network side. A specific implementation process and technical effects of the apparatus are the same as those in the method embodiment on the network side. For details, refer to the detailed descriptions in the method embodiment on the network side. Details are not described herein again.

The connection establishment apparatus in the embodiments of this application may be an electronic device, for example, an electronic device with an operating system, or may be a component in an electronic device, for example, an integrated circuit or a chip. The electronic device may be a terminal, or may be another device different from a terminal. For example, the terminal may include but is not limited to the foregoing listed types of the terminal 11. The another device may be a server, a Network Attached Storage (NAS), or the like. This is not specifically limited in the embodiments of this application.

The connection establishment apparatus provided in the embodiments of this application can implement the processes implemented in the method embodiments in FIG. 5 to FIG. 7, and achieve same technical effects. To avoid repetition, details are not described herein again.

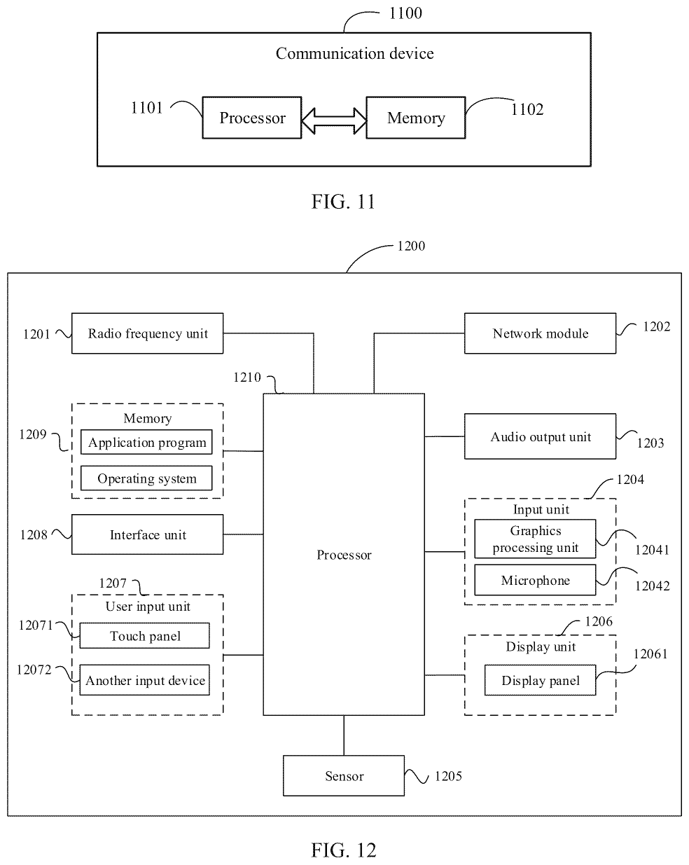

As shown in FIG. 11, an embodiment of this application further provides a communication device 1100, including a processor 1101 and a memory 1102. The memory 1102 stores a program or instructions capable of running on the processor 1101. For example, when the communication device 1100 is a first terminal, the steps in the connection establishment method embodiment on the first terminal side can be implemented when the program or the instructions are executed by the processor 1101, and same technical effects can be achieved. When the communication device 1100 is a second terminal, the steps in the connection establishment method embodiment on the second terminal side can be implemented when the program or the instructions are executed by the processor 1101, and same technical effects can be achieved. To avoid repetition, details are not described herein again.

An embodiment of this application further provides a first terminal, including a processor and a communication interface. The communication interface is configured to: when there is a first path between the first terminal and a network-side device, send first information to a second terminal or to the network-side device through a second terminal, where the first information is used to trigger establishment of a radio resource control RRC connection of the second terminal. The terminal embodiment corresponds to the foregoing method embodiment on the terminal side. Each implementation process and implementation of the foregoing method embodiment may be applied to the terminal embodiment, and same technical effects can be achieved.

An embodiment of this application further provides a second terminal, including a processor and a communication interface. The communication interface is configured to: receive first information from a first terminal; obtain first configuration information based on the first information; and establish a communication path based on the first configuration information, where the communication path includes a path between the second terminal and a network-side device and/or a path between the second terminal and the first terminal. The terminal embodiment corresponds to the foregoing method embodiment on the terminal side. Each implementation process and implementation of the foregoing method embodiment may be applied to the terminal embodiment, and same technical effects can be achieved.

FIG. 12 is a schematic diagram of a hardware structure of a first terminal or a second terminal according to an embodiment of this application.

The terminal 1200 includes but is not limited to at least some components of a radio frequency unit 1201, a network module 1202, an audio output unit 1203, an input unit 1204, a sensor 1205, a display unit 1206, a user input unit 1207, an interface unit 1208, a memory 1209, a processor 1210, and the like.

A person skilled in the art may understand that the terminal 1200 may further include a power supply (for example, a battery) that supplies power to each component. The power supply may be logically connected to the processor 1210 by using a power management system, to implement functions such as charging management, discharging management, and power consumption management through the power management system. The structure of the terminal shown in FIG. 12 does not constitute a limitation on the terminal. The terminal may include more or fewer components than those shown in the figure, or combine some components, or have different component arrangements. Details are not described herein again.

It should be understood that in this embodiment of this application, the input unit 1204 may include a Graphics Processing Unit (GPU) 12041 and a microphone 12042. The graphics processing unit 12041 processes image data of a still picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 or another input device 12072. The touch panel 12071 is also referred to as a touchscreen. The touch panel 12071 may include two parts: a touch detection apparatus and a touch controller. The another input device 12072 may include but is not limited to a physical keyboard, a function key (for example, a volume control key or an on/off key), a trackball, a mouse, and an operating lever. Details are not described herein again.

In this embodiment of this application, after receiving downlink data from a network-side device, the radio frequency unit 1201 may transmit the downlink data to the processor 1210 for processing. In addition, the radio frequency unit 1201 may send uplink data to the network-side device. Generally, the radio frequency unit 1201 includes but is not limited to an antenna, an amplifier, a transceiver, a coupler, a low-noise amplifier, a duplexer, and the like.

The memory 1209 may be configured to store a software program or instructions and various types of data. The memory 1209 may mainly include a first storage area for storing a program or instructions and a second storage area for storing data. The first storage area may store an operating system, an application program or instructions required by at least one function (for example, a sound play function or an image play function), and the like. In addition, the memory 1209 may include a volatile memory or a nonvolatile memory, or the memory 1209 may include both a volatile memory and a nonvolatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchronous link DRAM (SLDRAM), and a Direct Rambus RAM (DRRAM). The memory 1209 in this embodiment of this application includes but is not limited to these memories and any other suitable types of memories.

The processor 1210 may include one or more processing units. In some embodiments, the processor 1210 integrates an application processor and a modem processor. The application processor mainly processes operations related to an operating system, a user interface, an application program, and the like. The modem processor, for example, a baseband processor, mainly processes a wireless communication signal. It may be understood that the modem processor may not be integrated into the processor 1210.

The radio frequency unit 1201 is configured to:
when there is a first path between a first terminal and a network-side device, send first information to a second terminal or to the network-side device through a second terminal, where the first information is used to trigger establishment of a radio resource control RRC connection of the second terminal.

In some embodiments, the radio frequency unit 1201 is further configured to receive first configuration information sent by the network-side device, where the first configuration information includes configuration information of a second path, and the second path is a path for the first terminal to reach the network-side device through the second terminal.

In some embodiments, the radio frequency unit 1201 is further configured to send the first information to the second terminal through the second path or to the network-side device through the second terminal based on the first configuration information.

In some embodiments, the processor 1210 is further configured to perform a target operation based on the first configuration information, where the target operation includes any one of the following:
reconfiguring a transmission path of a first signaling radio bearer SRB message to the second path;
setting an RLC bearer corresponding to the second path to a main leg of the first SRB message; or
adding the second path, and setting a transmission path of the first information to a default path, where the default path is the second path.

In some embodiments, the first SRB message is an SRB1 message.

In some embodiments, the first information is a first signaling radio bearer SRB1 message.

In some embodiments, the radio frequency unit 1201 is configured to:
send the first information to the second terminal by using a discovery process; or
send the first information to the second terminal by using a target PC5 message, where the target PC5 message includes at least one of the following: a PC5-S message, a PC5-RRC message, or a PC5 layer 2 message.

In some embodiments, the first information includes a multi-path indicator and an identifier of a data transmission service.

In some embodiments, the radio frequency unit 1201 is configured to:
send the first information to the second terminal by using a first RLC bearer on a default PC5 interface.

In some embodiments, the first information is data or signaling to be transmitted to the network-side device, and the radio frequency unit 1201 is configured to:
reconfigure a transmission path of the first information from the first path to the first RLC bearer, and send the first information to the second terminal on the first RLC bearer through the second path; or
send the first information to the second terminal on the first RLC bearer in a transmission repetition manner through the second path.

In some embodiments, the radio frequency unit 1201 is further configured to:
when the first information does not meet a target condition for transmission on a second path, send the first information to the second terminal by using the first RLC bearer, where
the target condition is that an amount of cached data is greater than or equal to a first threshold.

In some embodiments, the radio frequency unit 1201 is further configured to:
when the first terminal has no to-be-transmitted data, send the first information to the second terminal on the first RLC bearer, where the first information is a control data packet; or
when the first terminal has no to-be-transmitted data, retransmit the first information to the second terminal on the first RLC bearer, where the first information is unacknowledged data of the first terminal.

In some embodiments, the first RLC bearer meets at least one of the following:

The first RLC bearer is a common PC5 RLC bearer reserved for a non-SRB0 and/or a non-SRB1;
the first RLC bearer is an RLC bearer separately reserved for at least two types of data; or
the first RLC bearer is an RLC bearer separately reserved for at least two data transmission requirements.

In some embodiments, the control data packet includes at least one of the following:
a layer 2 control data packet, a radio link control RLC layer control data packet, a packet data convergence protocol PDCP layer control data packet, or a service data adaptation protocol SDAP layer control data packet.

In some embodiments, when the control data packet is a PDCP layer control data packet or an SDAP layer control data packet, the control data packet is a data packet that needs to be sent to the network-side device.

In some embodiments, the first information includes a data packet type and a dedicated logical channel identifier LCID.

In some embodiments, the radio frequency unit 1201 is further configured to:
when a connection state of the second terminal is an idle state or an inactive state, send the first information to the second terminal or to the network-side device through the second terminal.

In some embodiments, the radio frequency unit 1201 is further configured to receive first indication information sent by the network-side device, where the first indication information is used to indicate a manner in which the first terminal sends the first information.

In some embodiments, the radio frequency unit 1201 is further configured to receive a notification message sent by the network-side device or the second terminal, where the notification message is used to notify a connection state of the second terminal.

In some embodiments, the first path is a direct path, and the second path is an indirect path.

An embodiment of this application further provides a network-side device, including a processor and a communication interface. The communication interface is configured to: when there is a first path between a first terminal and the network-side device, receive first information sent by the first terminal through a second terminal, where the first information is used to trigger establishment of a radio resource control RRC connection of the second terminal. The embodiment of the network-side device corresponds to the foregoing method embodiment of the network-side device. Each implementation process and implementation of the foregoing method embodiment of the network-side device may be applied to the embodiment of the network-side device, and same technical effects can be achieved.

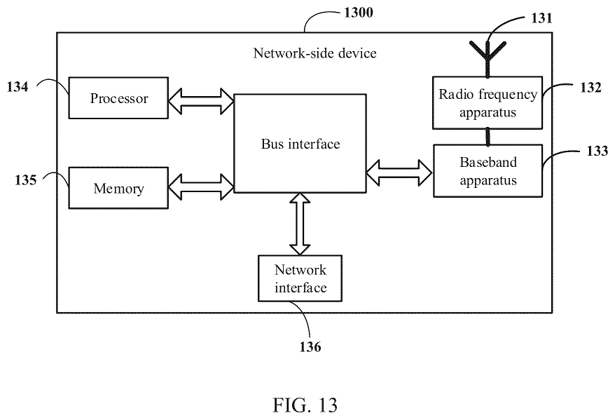

An embodiment of this application further provides a network-side device. As shown in FIG. 13, the network-side device 1300 includes an antenna 131, a radio frequency apparatus 132, a baseband apparatus 133, a processor 134, and a memory 135. The antenna 131 is connected to the radio frequency apparatus 132. In an uplink direction, the radio frequency apparatus 132 receives information through the antenna 131, and sends the received information to the baseband apparatus 133 for processing. In a downlink direction, the baseband apparatus 133 processes to-be-sent information, and sends processed information to the radio frequency apparatus 132. After processing the received information, the radio frequency apparatus 132 sends processed information through the antenna 131.

The method performed by the network-side device in the foregoing embodiment may be implemented in the baseband apparatus 133. The baseband apparatus 133 includes a baseband processor.

For example, the baseband apparatus 133 may include at least one baseband board. A plurality of chips are disposed on the baseband board. As shown in FIG. 13, one of the chips is, for example, the baseband processor, and is connected to the memory 135 by using a bus interface, to invoke a program in the memory 135 to perform the operation of the network device shown in the foregoing method embodiment.

The network-side device may further include a network interface 136. For example, the interface is a common public radio interface (CPRI).

The network-side device 1300 in this embodiment of this application further includes instructions or a program stored in the memory 135 and capable of running on the processor 134. The processor 134 invokes the instructions or the program in the memory 135 to perform the method performed by the modules shown in FIG. 10, and same technical effects are achieved. To avoid repetition, details are not described herein again.

An embodiment of this application further provides a readable storage medium. The readable storage medium stores a program or instructions. When the program or the instructions are executed by a processor, the processes in the foregoing connection establishment method embodiments are implemented, and same technical effects can be achieved. To avoid repetition, details are not described herein again.

The processor is a processor in the terminal in the foregoing embodiments. The readable storage medium includes a computer-readable storage medium. An example of the computer-readable storage medium includes a non-transient computer-readable storage medium, for example, a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing connection establishment method embodiments, and same technical effects can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes in the foregoing connection establishment method embodiments, and same technical effects can be achieved. To avoid repetition, details are not described herein again.

An embodiment of this application further provides a communication system, including a first terminal, a second terminal, and a network-side device. The first terminal may be configured to perform the steps of the connection establishment method of the first terminal, the second terminal may be configured to perform the steps of the connection establishment method of the second terminal, and the network-side device may be configured to perform the steps of the connection establishment method of the network-side device.

It should be noted that the terms “include”, “comprise”, or any other variations thereof in this specification are intended to cover a non-exclusive inclusion, so that a process, method, article, or apparatus that includes a list of elements includes those elements, and further includes other elements that are not expressly listed, or further includes elements inherent to such a process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in an order shown or discussed, and may further include performing functions in a basically simultaneous manner or in a reverse order based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or may be implemented by hardware. However, in many cases, the former is a better implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

1. A method of connection establishment, comprising:
when there is a first path between a first terminal and a network-side device, sending, by the first terminal, first information to a second terminal or to the network-side device through the second terminal, wherein the first information is used to trigger establishment of a radio resource control (RRC) connection of the second terminal.

2. The method according to claim 1, wherein the sending, by the first terminal, first information to a second terminal or to the network-side device through the second terminal comprises:
receiving, by the first terminal, first configuration information sent by the network-side device, wherein the first configuration information comprises configuration information of a second path, and the second path is a path for the first terminal to reach the network-side device through the second terminal; and
sending, by the first terminal, the first information to the second terminal through the second path or to the network-side device through the second terminal based on the first configuration information.

3. The method according to claim 2, further comprising:
performing, by the first terminal, a target operation based on the first configuration information, wherein the target operation comprises any one of the following:
reconfiguring a transmission path of a first signaling radio bearer (SRB) message to the second path;
setting a Radio Link Control (RLC) bearer corresponding to the second path to a main leg of the first SRB message; or
adding the second path, and setting a transmission path of the first information to a default path, wherein the default path is the second path.

4. The method according to claim 3, wherein the first SRB message is a first signaling radio bearer (SRB1) message.

5. The method according to claim 2, wherein the first information is a first signaling radio bearer (SRB1) message, or the first information is an RRC reconfiguration complete message.

6. The method according to claim 1, wherein the sending, by the first terminal, first information to a second terminal comprises:
sending, by the first terminal, the first information to the second terminal by using a discovery process; or
sending, by the first terminal, the first information to the second terminal by using a target PC5 message, wherein the target PC5 message comprises at least one of the following: a PC5-S message, a PC5-RRC message, or a PC5 layer 2 message.

7. The method according to claim 6, wherein the first information comprises at least one of the following: a multi-path indicator or an identifier of a data transmission service.

8. The method according to claim 1, wherein the sending, by the first terminal, first information to a second terminal comprises:
sending, by the first terminal, the first information to the second terminal by using a first Radio Link Control (RLC) bearer on a default PC5 interface.

9. The method according to claim 8, wherein the first information is data or signaling to be transmitted to the network-side device, and the sending, by the first terminal, the first information to the second terminal by using a first RLC bearer on a default PC5 interface comprises:
reconfiguring a transmission path of the first information from the first path to the first RLC bearer, and sending the first information to the second terminal on the first RLC bearer; or
sending the first information to the second terminal on the first RLC bearer in a transmission repetition manner.

10. The method according to claim 8, wherein the sending, by the first terminal, the first information to the second terminal by using a first RLC bearer on a default PC5 interface comprises:
when the first information does not meet a target condition for transmission on a second path, sending, by the first terminal, the first information to the second terminal by using the first RLC bearer, wherein the target condition is that an amount of cached data is greater than or equal to a first threshold.

11. The method according to claim 8, wherein the sending, by the first terminal, the first information to the second terminal by using a first RLC bearer on a default PC5 interface comprises:
when the first terminal has no data or signaling to be transmitted to the network-side device, sending, by the first terminal, the first information to the second terminal on the first RLC bearer, wherein the first information is a control data packet; or
when the first terminal has no data or signaling to be transmitted to the network-side device, retransmitting, by the first terminal, the first information to the second terminal on the first RLC bearer, wherein the first information is unacknowledged data of the first terminal.

12. The method according to claim 11, wherein the control data packet comprises at least one of the following:
a layer 2 control data packet, a radio link control (RLC) layer control data packet, a packet data convergence protocol (PDCP) layer control data packet, or a service data adaptation protocol (SDAP) layer control data packet.

13. The method according to claim 11, wherein when the control data packet is a packet data convergence protocol (PDCP) layer control data packet or a service data adaptation protocol (SDAP) layer control data packet, the control data packet is a data packet that needs to be sent to the network-side device.

14. The method according to claim 8, wherein the first information comprises at least one of the following: a data packet type and a dedicated logical channel identifier (LCID).

15. The method according to claim 1, wherein the sending, by the first terminal, first information to a second terminal or to the network-side device through the second terminal comprises:
when a connection state of the second terminal is an idle state or an inactive state, sending, by the first terminal, the first information to the second terminal or to the network-side device through the second terminal.

16. The method according to claim 1, further comprising:
receiving, by the first terminal, first indication information sent by the network-side device, wherein the first indication information is used to indicate a manner in which the first terminal sends the first information.

17. The method according to claim 1, further comprising:
receiving, by the first terminal, a notification message sent by the network-side device or the second terminal, wherein the notification message is used to notify a connection state of the second terminal.

18. The method according to claim 2, wherein the first path is a direct path, and the second path is an indirect path.

19. A first terminal, comprising: a memory storing a computer program; and a processor coupled to the memory and configured to execute the computer program to perform operations comprising:
when there is a first path between the first terminal and a network-side device, sending, by the first terminal, first information to a second terminal or to the network-side device through the second terminal, wherein the first information is used to trigger establishment of a radio resource control (RRC) connection of the second terminal.

20. A non-transitory computer-readable storage medium, storing a computer program, wherein the computer program, when executed by a processor, causes the processor to perform operations comprising:
when there is a first path between a first terminal and a network-side device, sending, by the first terminal, first information to a second terminal or to the network-side device through the second terminal, wherein the first information is used to trigger establishment of a radio resource control (RRC) connection of the second terminal.
